(19) United States
(12) Patent Application Publication
(10) Pub. No.: US 2006/0233454 A1
(43) Pub. Date: Oct. 19, 2006

(54) Method for image intensity correction using extrapolation and adaptive smoothing

(76) Inventors: Hu Cheng, Gainesville, FL (US); Feng Huang, Gainesville, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/281,523

(22) Filed: Nov. 16, 2005

Related U.S. Application Data
(60) Provisional application No. 60/671,615, filed on Apr. 15, 2005.

(51) Int. Cl. G06K 9/40

(52) U.S. Cl. 382/274

(57) ABSTRACT

The subject invention pertains to a method of image intensity correction. The subject invention can utilize extrapolation for image intensity correction. The use of extrapolation can reduce the artifacts during intensity correction as compared to traditional methods of intensity correction. The extrapolation can be combined with, for example, homomorphic filtering methods, parametric estimation techniques, wavelet based method, and/or Gaussian smooth method, in order to reduce the artifacts generated by these methods and improve the quality of correction. The implementation of image extrapolation in accordance with a specific embodiment can utilize closest point method. The subject method can also use adaptive smoothing for image intensity correction. In an embodiment, the use of gradient weighted smoothing method can reduce, or eliminate, over-smoothing of bright spot regions. In a specific embodiment, the subject method can utilize gradient weighted partial differential equation (PDE) smoothing.

### CROSS-REFERENCE TO RELATED APPLICATION

This application claims the benefit of U.S. Provisional Application Ser. No. 60/671,615, filed Apr. 15, 2005, which is hereby incorporated by reference herein in its entirety, including any figures, tables, or drawings.

### BACKGROUND OF INVENTION

The subject invention relates generally to a method for image intensity correction. In various embodiments, the subject invention pertains to the use of extrapolation and/or adaptive smoothing. In a specific embodiment, the subject method can be applied to magnetic resonance imaging (MRI).

MRI images often suffer from non-uniformity that gives false image contrasts. Therefore, intensity correction of the images often becomes important in order to interpret the image correctly.

There are many approaches to intensity correction of images, such as MRI images. Non-retrospective methods include: phantom based methods, simulation methods, special coil methods, extra body coil scans, and special acquisition schemes. These methods require modifications to the actual imaging procedure and cannot be applied to previously acquired images. Retrospective methods include: homomorphic filtering methods, parametric estimation techniques, wavelet based methods, Gaussian smooth methods, N3, and interleaving segmentation with intensity correction method. The subject invention falls into the category of retrospective methods.

Image intensity inhomogeniety is often perceived as a smooth variation of intensity across the image. Intensity inhomogeniety can hinder visualization of the entire image, and can also hinder automated image analysis, like segmentation. Magnetic resonance imaging (MRI) can have this problem because of, for example, poor radio frequency (RF) coil uniformity, static field inhomogeniety, radio frequency penetration, gradient-driven eddy currents, and/or overall patient anatomy and position. Surface RF coils can have poor B₁ field (Magnetic field generated by a unit current in the radio frequency coil) uniformity and, hence, generate inhomogeneous images. Phased array surface RF coils can improve the homogeneity but still suffer from non-uniformity, such as bright spots in the image. Because surface coils dramatically improve image signal to noise ratio (SNR) and phased array surface RF coils are essential for parallel imaging techniques, surface coils are widely used and, therefore, intensity inhomogeniety is frequently encountered clinically. Accordingly, intensity correction has become a desired post-processing step for MRI with surface coils. The goal of intensity correction is to correct image intensity without significantly, if at all, affecting the image contrast.

The distorted image can be viewed as the summation of noise and the multiplication of a sensitivity profile of the system and the true image. Sensitivity profile is determined by the property and position of the scanned object, coil geometry, and other factors. If an accurate sensitivity profile were available, then dividing the original corrupted image with the sensitivity profile would generate a homogenous image. However, an accurate sensitivity profile cannot be directly measured or calculated. It is possible to approximately calculate or measure the sensitivity profile. Different methods have been described to determine the sensitivity profile for the purpose of intensity correction.

Non-Retrospective Methods Include:

phantom based method (D. A. G. Wicks, G. J. Barker, and P. S. Tofts, “Correction of intensity non-uniformity in MR images of any orientation,” Mag. Reson. Imag, vol. 11, pp. 183-196, 1993; L. Axel, J. Costantini, and J. Listerud, “Intensity correction in surface-coil MR imaging,” Am. J. Roentgenology, vol. 148, pp. 418-420, 1987; M. Tincher, C. R. Meyer, R. Gupta, and D. M. Williams, “Polynomial modeling and reduction of RF body coil spatial inhomogeneity in MRI,” IEEE Trans. Med. Imag, vol. 12, pp. 361-365, 1993);

simulation method (S. E. Moyher, D. B. Vigneron, and S. J. Nelson, “Surface coil MR imaging of the human brain with an analytic reception profile correction,” J. Magn. Resonance Imag, vol. 5, pp. 139-144, 1995.; S. E. Moyher, L. Wald, S. J. Nelson, D. Hallam, W. P. Dillon, D. Norman, and D. B. Vigneron, “High resolution T2-weighted imaging of the human brain using surface coils and an analytical reception profile correction.,” J. Mag. Res. Imag, vol. 7, pp. 512-517, 1997);

special coil method (T. K. Foo, C. E. Hayes, and Y. W. Kang, “Analytical model for the design of RF resonators for MR body imaging,” Mag. Res. Med, vol. 21, pp. 165-177, 1991; M. Singh and M. NessAiver, “Accurate Intensity Correction for the Endorectal Surface Coil MR Imaging of the Prostate,” pp. 1307-1309, 1993; G. P. Liney, L. W. Turnbull, and A. J. Knowles, “A simple method for the correction of endorectal surface coil inhomogeneity in prostate imaging,” J. Mag. Res. Imag, vol. 8, pp. 994-997, 1998), extra body coil scan (W. W. Brey and P. A. Narayana, “Correction for intensity falloff in surface coil magnetic resonance imaging,” Med. Phys., vol. 15, pp. 241-245, 1998; S.-H. Lai and M. Fang, “Intensity inhomogeneity correction for surface-coil MR images by image fusion.,” presented at International Conference on Multisource-Multisensor Information Fusion, 1998; K. P. Pruessmann, M. Weiger, M. B. Scheidegger, and P. Boesiger, “SENSE: Sensitivity encoding for fast MRI,” Magn Reson Med, vol. 42, pp. 952-962, 1999; A. C. Fan, “A Variational Approach to MR Bias Correction,” in Department of Electrical Engineering and Computer Science. Boston: Massachusetts Institute of Technology, 2003, pp. 193); and

special acquisition scheme (J. Wang, M. Qiu, Q. X. Yang, M. B. Smith, and T. R. Constable, “Correction of Transmission and Reception Fields Induced Signal Intensity Nonuniformities In Vivo,” presented at Intl. Soc. Mag. Reson. Med. 11, TOKOYO, Japan, 2004). These methods require modifications to the actual imaging procedure and cannot be applied to previously acquired MR images.

Retrospective Methods Include:

parametric estimation techniques (C. Brechb\ddot{}uhler, G. Gerig, and G. Sz´ekely, “Compensation of spatial inhomogeneity in MRI based on a parametric bias estimate,” presented at Visualization in Biomedical Computing (VBC '96) (Lecture Notes in Computer Science), Berlin, Germany, 1996; B. M. Dawant, A. P. Zijdenbos, and R. A. Margolin, “Correction of Intensity Variations in MR Images for Computer-Aided Tissue Classification,” IEEE Trans. Med. Imag, vol. 12, pp. 770-781, 1993.; M. Styner, C. Brechbuhler, G. Szekely, and G. Gerig, “Parametric estimate of intensity inhomogeneities applied to MRI,” IEEE Trans. Med. Imag, vol. 19, pp. 153-165, 2000; B. t. Likar, M. A. Viergever, and F. Pemus, “Retrospective Correction of MR Intensity Inhomogeneity by Information Minimization,” presented at Medical Image Computing and Computer-Assisted Intervention—MICCAI, pp. 375-384 2000; B. Likar, J. B. A. Maintz, M. A. Viergever, and F. Pemus, “Retrospective shading correction based on entropy minimization,” J. of Microscopy, vol. 197, pp. 285-295, 2000; P. Viola, “Alignment by Maximization of Mutual Information,” MIT Ph.D. dissertation, 1995; R. P. Velthuizen, J. J. Heine, A. B. Cantor, H. Lin, L. M. Fletcher, and L. P. Clarke., “Review and evaluation of MRI nonuniformity corrections for brain tumor response measurements,” Med. Phys., vol. 25, pp. 1655-1666, 1998; A. A. Samsonov, R. T. Whitaker, E. G. Kholmovski, and C. R. Johnson, “Parametric Method for Correction of Intensity Inhomogeneity in MRI Data,” presented at Intl. Soc. Mag. Reson. Med. 10, Honolulu, Hi., USA, p 154, 2002, N3 (J. G. Sled, A. P. Zijdenbos, and A. C. Evans, “A nonparametric method for automatic correction of intensity nonuniformity in MRI data,” IEEE Trans. Med. Imag., vol. 17, pp. 87-97, 1998);

interleaving segmentation with intensity correction methods (C. R. Meyer, P. H. Bland, and J. Pipe, “Retrospective correction of MRI amplitude inhomogeneities,” presented at First Int. Conf. Computer Vision, Virtual Reality, Robotics Medicine (CVRMED'95) (Lecture Notes in Computer Science), Berlin, Germany, pp. 513-522, 1995; C. R. Meyer, P. H. Bland, and J. Pipe, “Retrospective correction of intensity inhomogeneities in MRI,” IEEE Trans. Med. Imag, vol. 14, pp. 36-41, 1995; S. K. Lee and V. M. W., “Post-acquisition correction of MR inhomogeneities.,” Mag. Res. Med., vol. 36, pp. 275-286, 1996; W. M. Wells, W. E. L. Grimson, R. Kikinis, and F. A. Jolesz, “Adaptive segmentation of MRI data,” IEEE Trans. Med. Imag., vol. 15, pp. 429-442, 1996; R. Guillemaud and M. Brady., “Estimating the bias field of MR images,” IEEE Trans. Med. Imag., pp. 238-251, 1997; K. Held, E. R. Kops, B. J. Krause, W. M. W. III, R. Kikinis, and H.-W. M\ddot{}uller-G\ddot{}artner, “Markov random field segmentation of brain MR images,” IEEE Trans. Med. Imag, vol. 16, pp. 878-886, 1997; Y. Zhang, M. Brady, and S. Smith., “Segmentation of brain MR images through a hidden Markov random field model and the Expectation-Maximization algorithm.,” IEEE Trans. Med. Imag, vol. 20, pp. 45-57, 2001);

homomorphic filtering methods (J. Haselgrove and M. Prammer, “An algorithm for compensation of surface-coil images for sensitivity of the surface coil,” Mag. Res. Imag., vol. 4, pp. 469-472, 1986; R. C. Gonzalez and R. E. Woods, Digital Image Processing: MA: Addison-Wesley, 1993; B. H. Brinkmann, A. Manduca, and R. A. R. “Optimized homomorphic unsharp masking for MR grayscale inhomogeneity correction,” IEEE Trans. Med. Imag., vol. 17, pp. 161-171, 1998; N. D. Gelber, R. L. Ragland, and J. R. Knorr, “Surface coil MR imaging: utility of image intensity correction filter,” Am. J. Roentgenology, vol. 162, pp. 695-697, 1994; R. Guillemaud, “Uniformity correction with homomorphic filtering on region of interest.,” presented at the 1998 International Conference on Image Processing, pp. 872-875, 1998; R. B. Lufkin, T. Sharpless, B. Flannigan, and W. Hanafee., “Dynamic-range compression in surface-coil MRI,” Am. J. Roentgenology, vol. 147, pp. 379-382, 1986); and

wavelet based method (F.-H. Lin, Y.-J. Chen, J. W. Belliveau, and L. L. Wald, “Removing Signal Intensity Inhomogeneity from Surface Coil MRI Using Discrete Wavelet Transform and Wavelet Packet,” presented at Engineering in Medicine and Biology Society, 2001, 23rd Annual International Conference of the IEEE, 2001; and

Gaussian smoothing method (M. S. Cohen, R. M. DuBois, and M. M. Zeineh, “Rapid and Effective Correction of RF Inhomogeneity for High Field Magnetic Resonance Imaging,” Human Brain Mapping, vol. 10, pp. 204-211, 2000).

In parametric estimation techniques, the sensitivity profile is represented as a sum of basis functions, and the intensity correction algorithm only modifies the parameters that control the sum. Generally an energy functional is constructed and minimized to determine which parameters provide the best fit. Some kind of prior information (reference points within one tissue class, mean and noise variance of each tissue class) is usually necessary for this kind of method. And the correction times are dependant on the number of parameters in the model used. While the N3 algorithm provides a genuinely automatic non-uniformity estimate, it still falls short at several levels. Although trivial in most images, the foreground needs to be segmented from the background, thus making intensity correction difficult for regions of interest where the signal drops to noise level. The necessarily iterative nature of the N3 method introduces biases caused by non-uniform noise levels in the iterative images that are additive and not multiplicative. Segmentation based intensity correction methods have a tendency to generate piecewise constant images and typically do not handle bright spots effectively.

Homomorphic filtering methods, Wavelet based methods, and Gaussian kernel smoothing methods all assume that the sensitivity profile information is low frequency information. These methods tend to treat all image pixels the same and smooth uniformity everywhere. This means the estimated sensitivity profiles could be too smooth at regions closer to the coil, and hence it is difficult to get rid of the bright spots that are common in MRI with phased array coils. These methods also exhibit the edge enhancement problem at the image boundary (between the image support, which is the region containing most of the signal strength, and holes, which is the region containing almost no signal strength, in the image). This is because there is an inherent lack of information of sensitivity profile outside of the boundary. Therefore, the filter generates errors near the boundary. Cohen et al. (M. S. Cohen, R. M. DuBois, and M. M. Zeineh, “Rapid and Effective Correction of RF Inhomogeneity for High Field Magnetic Resonance Imaging,” Human Brain Mapping, vol. 10, pp. 204-211, 2000) proposed to use image intensity average to fill these unknown holes. This does reduce the error but does not eliminate the problem, especially when the average is significantly different from the boundary intensity values. This means the estimated sensitivity profiles could be too smooth at regions closer to the coil, and hence it is difficult to get rid of the bright spots that are common in MRI with surface coils. Homomorphic filtering methods process k-space and assume that the frequency spectrum of the sensitivity profile and the image structures are well separated. But this assumption is generally not valid for MR images (D. A. G. Wicks, G. J. Barker, and P. S. Tofts, “Correction of intensity non-uniformity in MR images of any orientation,” Mag. Reson. Imag, vol. 11, pp. 183-196, 1993; B. M. Dawant, A. P. Zijdenbos, and R. A. Margolin, “Correction of Intensity Variations in MR Images for Computer-Aided Tissue Classification,” IEEE Trans. Med. Imag, vol. 12, pp. 770-781, 1993). One of the many issues that homomorphic filtering has is that it tends to underestimate the bias field at tissue/air boundaries. Wavelet based method and Gaussian kernel smoothing method estimate the sensitivity profile in the image space by smoothing the original image. However, the smoothing is non-adaptive; hence, it is difficult to balance the preservation of contrast and the removal of bright spots. These methods typically always have the same problem at the image boundary. Another problem of these those methods is that they treat all image pixels equally, which means the intensity correction map could be too smooth. Accordingly, it is difficult to get rid of the hot spots, which are common in MRI with surface coils.

Partial differential equation (PDE) based image processing methods have been widely applied (T. F. Chan, J. Shen, and L. Vese, “Variational PDE models in image processing,” Amer. Math. Soc. Notice, vol. 50, pp. 14-26, 2003). Closest point based methods are also known (Y. R. Tsai, “Rapid and Accurate Computation of the Distance Function Using Grids,” UCLA CAM, Los Angeles 00-36, 2000).

### BRIEF DESCRIPTION OF DRAWINGS

FIGS. 1A-1P show the results of simulated phantom data, where FIG. 1A shows the true image; FIG. 1B shows the simulated B₁ field; FIG. 1C shows the intensity corrupted image; FIG. 1D shows extrapolation results based on FIG. 1C; FIG. 1E shows a filtered gradient map of FIG. 1D; FIGS. 1F and 1G show a sensitivity profile and a corrected image, respectively, in accordance with an embodiment of the subject invention utilizing gradient weighted smoothing; FIGS. 1H and 1I show a sensitivity profile and a corrected image, respectively, in accordance with a method utilizing the Gaussian kernel smoothing method; FIGS. 1J and 1K shows a sensitivity profile and a corrected image, respectively, in accordance with a method utilizing the wavelet based method; FIGS. 1L and 1M show a sensitivity profile and a corrected image, respectively, in accordance with a method utilizing the homomorphic filtering method; FIGS. 1N-1O show a sensitivity profile and a correction image, respectively, in accordance with a method utilizing non-weighted PDE smoothing (nwp) method; and FIG. 1P shows the plot of histograms of corrected images and the true image, where all the images used the same intensity scales [0 1], except the gradient map of FIG. 1E that used intensity scale [0 13.65] and all the corrected images have the same average intensity value.

FIGS. 2A-2H show the intensity correction results for images collected by different systems and corrected with the same set of parameters, where FIG. 2A shows a cardiac image using a GE 4-channel cardiac coil on a GE 1.5 T system; FIG. 2B shows a brain image using an Invivo 8-channel brain coil on a SIEMENS 1.5 T system; FIG. 1C shows a neurovascular image using an Invivo 8-channel NVA coil on a GE 1.5 T system; FIG. 2D shows a brain image using Hitachi 4-channel brain coil on a Hitachi 1.5 T system; and FIGS. 2E-2H are the images shown in FIGS. 2A-2D, respectively, corrected in accordance with an embodiment of the subject method.

FIGS. 3A and 3B show an original image and an extended image, respectively, where the hole pixels near image support pixels have been assigned values related to image support pixel value of image support pixels they are near, in accordance with a specific embodiment of the subject invention.

### DETAILED DISCLOSURE

The subject invention pertains to a method of image intensity correction. The subject invention can utilize extrapolation for image intensity correction. The use of extrapolation can reduce the artifacts during intensity correction as compared to traditional methods of intensity correction. The extrapolation can be combined with, for example, homomorphic filtering methods, parametric estimation techniques, wavelet based method, and/or Gaussian smooth method, in order to reduce the artifacts generated by these methods and improve the quality of correction. The implementation of image extrapolation in accordance with a specific embodiment can utilize closest point method. The use of closest point method can reduce the computation time and improves the efficiency of finding the boundary. The use of image extrapolation by mapping can reduce edge signal enhancement artifacts. To reduce, or eliminate, high gradient between tissue and air boundary, image extrapolation technique can be utilized in accordance with the subject invention. The extrapolation can also reduce the boundary enhancement problem and the difficulty of intensity correction in regions where the signal drops to noise level.

The subject method can also use adaptive smoothing for image intensity correction. In an embodiment, the use of gradient weighted smoothing method can reduce, or eliminate, over-smoothing of bright spot regions. In a specific embodiment, the subject method can utilize gradient weighted partial differential equation (PDE) smoothing. In a specific embodiment, gradient weighted PDE smoothing model is used for hot spots searching and correction. Compared to homomorphic filtering methods, parametric estimation techniques, wavelet based method, and Gaussian smooth method, gradient weighted PDE smoothing method, can provide adaptive correction for areas with different degrees of distortion instead of using one parameter for the whole image. In addition, PDE smoothing can be much faster.

In an MR image, with the exception of the tissue/air boundary, even high intensity regions like fat should have relatively low gradient if the sensitivity profile is uniform. However, bright spots caused by non-uniform sensitivity profiles often have a high gradient. Accordingly, in accordance with an embodiment of the subject method, gradient values may distinguish the degree of non-uniformity of sensitivity profile. In an embodiment, the subject gradient weighted smoothing method smoothes less at high gradient regions to remove the bright spots, and smoothes more at low gradient region to protect the image contrast.

Specific embodiments of the subject method can address the boundary information problem and/or smoothing problem that exists in prior intensity correction methods. Image extrapolation can be utilized to address the boundary information problem, so as to improve the intensity correction performance at boundary regions. In an embodiment, partial differential equation (PDE) based smoothing method can be implemented to address the smoothing problem. In an embodiment, PDE based image-smoothing can be used here for weighted smoothing.

In accordance with a specific embodiment, image extrapolation is first performed; a smoothing weight is then defined; weighted smoothing is then performed; and image correction is then performed. In a specific embodiment, the method can be iterative such that the four actions are repeated. Image extrapolation can provide information for smoothing near the boundary regions and/or out of the boundary. For an intensity-corrupted image, it is often true that some part of the image has very low intensity. These low intensity regions can be referred to as holes. In this way, a boundary can be between the image support and the holes in the image. Once the boundaries are obtained, for each pixel not in the image support (i.e., for each pixel in the holes) a value can be assigned to the pixel. In a specific embodiment, one, and only one, pixel inside the boundary, and part of the image support, can be determined that is the mirror image of the pixel outside the boundary, and not in the image support, with respect to the boundary. The pixel not in the anatomy, or image support, can be assigned the intensity value of the mirror image pixel such that the two pixels, which are mirror images of each other, have the same intensity value.

Various techniques can be used to find the boundary. Examples of techniques to find the boundary include active contours and fuzzy cluster. In an embodiment, the gradient of the background mask can be used to find the boundary and the closest point method can be used to implement image mapping. A detailed description of the closest point method can be found in reference Y. R. Tsai, “Rapid and Accurate Computation of the Distance Function Using Grids,” UCLA CAM, Los Angeles 00-36, 2000, which is herein incorporated by reference in its entirety.

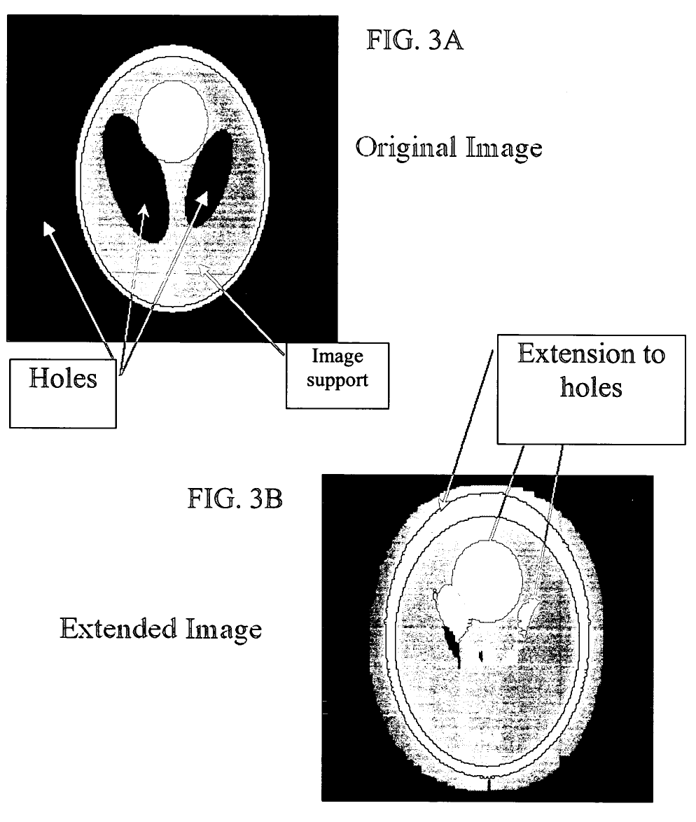

In a specific embodiment of the subject method, we can let I be the corrupted, or original, image and Î be the extrapolated image. The low intensity regions are regions having hole pixels, and the remaining pixels can be referred to as image support pixels. The low intensity regions I_{L} in the image can be found, which are holes in the image. The determination of hole pixels and image support pixels can be done by, for example, setting an intensity threshold and determining the pixels with the intensities, or magnitudes, lower than the intensity threshold as hole pixels, or low intensity regions. In an embodiment the intensity threshold is a percentage of the maximum intensity of this image. Other ways include, but are not limited to, determining pixels with magnitudes lower than a multiple of the noise level as hole pixels. The difference between corrupted image and the low intensity regions, I−I_{L}, can be referred to as the image support, or image support pixels. Reference can be made to FIGS. 3A and 3B. In FIG. 3A, the original, or corrupted, image is shown. A determination has been made that the magnitude of some pixels in the original image are low enough to be defined as hole pixels and the regions having these hole pixels are labeled “holes”, while the remaining pixels are image support pixels and are labeled “image support”. In order to accomplish intensity correction, an intensity correction map can be generated. In order to generate an intensity correction map, an intensity correction template can be produced. The intensity correction template is produced by first setting as correction values for the image support pixels in the intensity correction template the magnitude values of the image support pixels from the original image. Then, hole pixels that are near the image support pixels in the intensity correction template can have correction values set that are related to the correction values of the image support pixels that the hole pixels are near. In various embodiments, correction value of a hole pixel near an image support pixel in the intensity correction template can be, for example, the correction value of the closest image support pixel, the correction value of a mirror image image support pixel of the hole pixel, an average correction value of the image support pixel that the hole pixel is near, or some other correction value that is related to the correction values of the image support pixels the hole pixel is near. FIG. 3B shows an intensity correction template created with respect to the original image in FIG. 3A, in accordance with a specific embodiment of the subject invention. The hole pixels that are near image support pixels are referred to as “extension to holes”. Another term for assigning the hole pixels near image support pixels values related to the image support pixel they are near, used in the subject application, includes extrapolation.

In this way, the intensity correction template has values for the image support pixels and for at least a portion of, and preferably all of, hole pixels near the image support pixels, where, in a specific embodiment, near can mean within a certain distance or within a certain number of pixels, such as 20 pixels, 50 pixels, or 100 pixels. In an embodiment, select portions of the hole pixels near image support pixels, such as those within the anatomy of the image object and not in the background, can be assigned values. In another embodiment, all hole pixels near image support pixels can be assigned values. The intensity correction map can then be generated by altering the correction values of the image support pixels based on the values of the hole pixels near the image support pixels and the values of the image support pixels in the intensity correction template. In various embodiments, a variety of smoothing and/or filtering methods can be utilized to accomplish altering the values of image support pixels in the intensity correction template to create the intensity correction map. In this way, the intensity correction map has values for the image support pixels.

Once the intensity correction map is generated, a corrected image can be produced by dividing the values of the image support pixels in the original image by the correction values of the corresponding image support pixels in the intensity correction map and producing a magnitude value for the image support pixel in the corrected image proportional to this result.

In further embodiments, the intensity correction template can include values for hole pixels not near the image support pixels. Such values can be, for example, 0, a constant value, some value proportional to the average value of the magnitudes of the pixels, some value proportional to the noise level. Additional embodiments can take these hole pixel values into account when generating the values of the image support pixels in the intensity correction map.

In specific embodiments, a boundary can be defined between hole pixel regions and image support pixel regions. Examples of such boundaries include: image support pixels that are adjacent to a hole pixel; hole pixels that are adjacent to image support pixels; and a curve lying between hole pixels and adjacent image support pixels. Other boundaries can also be utilized. These boundaries can be utilized when assigning values to hole pixels near image support pixels by, for example, helping to define mirror-image image support pixels of hole pixels near image-support pixels.

In a specific embodiment, two matrices of the same size as the image are used for records. One matrix M can record the status of each pixel. Three values can be used in M. These values can be referred to as white, black, and gray, respectively. White, which can be a value of 1, means the intensity of this pixel has been defined; Black, which can be a value of 0, means that there is no intensity information for this pixel; Gray, which can be a value of 2, means there is an intensity definition of this pixel but there is uncertainty with respect to the accuracy of the intensity definition. For initialization, pixels in the low intensity region can be defined as black (0) in M. Pixels in all other places can be defined as white (1) in M.

Another matrix V is used to record the closest point of each pixel. For a fixed point x, the closest point of x is the point in the image support that has the closest distance to x. Hence for any pixel in the image support, the closest point is itself and V has value at image support. Therefore, initially each white pixel is assigned a closest point that is actually itself. For pixels in the low intensity region, the closest point is unknown. One approach is to actually calculate the distance from this point to all pixels in the image support, and find the smallest one. However, for an image with a big size, this method can be too expensive. In an embodiment, the closest point method can be used. An example of this technique can be described for a 2-dimensional case. This technique can be applied for a 3-dimensional case as well. In a specific embodiment, the black regions that have distance less than \sqrt{2} (where distance between adjacent pixels is 1 and distance between diagonal pixels is \sqrt{2}) to the white region are found, and pixels in these regions are redefined to be gray. To find those regions, we let B be a mask, such that B is 0 at low intensity region but 1 everywhere else. We calculate the gradient of B and find the pixels that have a gradient greater than or equal to 0.25. All of those pixels that have a high gradient but are not white are defined to be gray. For all of those gray pixels, they have one or more \sqrt{2} neighbors in the white region, where \sqrt{2} neighbor means the neighbors that have distance less than or equal to \sqrt{2}. Hence we only need scan all 8 \sqrt{2} neighbors to find those white neighbors. For a specific point x in gray regions, once we find one white \sqrt{2} neighbor y (that has closest point y′, notice V records the closest point for white pixel), we let the intensity of x be same as the intensity of symmetric point across y′, and record y′ as its (x's) own closest point in V. If the symmetric point of x is not white then we assign the intensity of y′ to x. Then we continue to scan its \sqrt{2} neighbors. If another white neighbor z is found which has closest point z′, the distance from x to z′ and the distance from x to y′ is compared, and choose the smaller one as the closest point for x. Update the intensity of x, if the closest point is changed. If a black neighbor is met during scan, we change the color of that black neighbor be gray. When all 8 neighbors are scanned, we change the color of x be white. We stop the process when all pixels become white or the distance from the gray pixels to their closest points are greater than a given number. Please refer to T. K. Foo, C. E. Hayes, and Y. W. Kang, “Analytical model for the design of RF resonators for MR body imaging,” Mag. Res. Med, Vol. 21, pp. 165-177, 1991, for more details of the idea of closest point. If a threshold is used for termination, then the remaining undefined region can be assigned to be the average intensity value.

MR images produced from data acquired with phased array surface coils often have hot spots, or regions with high intensity values. Suppose the sensitivity profile, or correction map, of the original corrupted image I is S, the corrected image should be R=I/S. According to Biot-Savart law, B₁ field changes much faster in regions nearer to the coil than the regions farther away from it. Hence it is reasonable that the estimated sensitivity profile S has location related smoothness. Specific embodiments of the subject method can assume that the sensitivity profile may have high frequency information if the coil is very close to the patient. The assumption is based on Biot-Savart law. Accordingly, the high frequency information of sensitivity profile can be protected during approximation. The gradient map G of an image can provide the frequency information of image intensity. When the gradient is high, it means the image intensity changes fast and has more high frequency information. A high gradient can be caused by, for example, either an image boundary or non-uniform sensitivity profiles. A high gradient caused by an image boundary typically has higher frequency than a high gradient caused by a non-uniform sensitivity profile.

Therefore, the high gradient caused by an image boundary can be filtered out by using low pass filter in the frequency domain. Low pass filtered gradient map Ĝ demonstrate the smoothness degree of the sensitivity profile and the multiplication of the gradient map and a constant, λ, can be used as a weight to perform smoothing. The constant, λ, is a parameter that can be selected based on the smoothing method and the image properties. To reduce, or avoid, the influence of noise, Î can be slightly smoothed before the calculation of G. To remove the high gradient caused by the image boundary, G can be mapped to frequency domain and operated by a low pass filter. The filtered result can then be mapped back to real domain and the smoothing weight Ĝ generated. In this way, regions that have hot spots are less smoothed, while all other regions are more smoothed.

In an embodiment, a partial differential equation (PDE) based isotropic model can be used for smoothing. PDE has been widely used for image processing. The advantage of PDE based image smoothing is that the smoothness can be easily controlled locally. Therefore PDE based image smoothing is more accurate than other globally controlled smoothing methods.

In an embodiment, a gradient weighted isotropic smoothing model can be used to do the smoothing. In an embodiment, an energy function is defined that is related to the smoothness and contrast of the image. By numerically solving the Euler Lagrange equation to minimize the energy under certain boundary conditions, the sensitivity map can be determined. The image intensity can then be corrected. In a specific embodiment, there are 4 parameters in the algorithm. One parameter, ε, is a positive number used to define the low intensity regions in the image. This threshold can be automatically determined in several ways. One simple approach is finding the maximum pixel intensity in the entire image and set ε to be a portion of this value, such as 0.05 times this value [i.e., 0.05×(maximum intensity)]. The second parameter is W, which defines the distance of image extrapolation. A large W takes a longer extrapolation time. As an approximate value is needed near the boundary, W can be 20 in a specific implementation. A larger W may be desired if there is a big region with low intensity in the image. The third parameter, λ, is used to balance the fidelity term and the smooth term. The last parameter is the number of iterations, N. In an embodiment seeking an S that is smooth and structureless a small value for λ and big N are used, A small λ can protect the original image contrast better, but may hamper the correction of hot spots. If a relatively big λ is chosen, the whole correction process may need to be repeated to eliminate the hot spots. In a specific implementation, λ is chosen to be 0.01. A larger N can protect original image contrast better but take longer processing time. In a specific implementation, N is fixed to be 100.

Equation 1 shows an equation that can be utilized, in a specific embodiment of the subject invention, for gradient weighted isotropic smoothing. Ω is the image domain, ‘∇’ is the gradient operator. Given the extrapolated image Î and the filtered gradient map Ĝ, the sensitivity profile S that minimizes the energy functional E can be the smoothing result.
E(S)=∫_{Ω}λĜ(S−Î)²+|∇S|²dx (1)
The first term is usually called the “fidelity term”, which protects the original image intensity value, and hence resists any change such as smoothing. The second term |∇S|² is usually called the “smoothing term”, which smoothes the image by reducing the image gradient. PDEs can use diffusion for smoothing. Two basic types of diffusion are isotropic and anisotropic. Isotropic, in this context, means the weights are independent of direction from the pixel. The weights can decrease with distance from the pixel. In an embodiment, isotropic diffusion is utilized. The selection of isotropic diffusion in this embodiment can, at least partly, benefit from the assumption that sensitivity profile for intensity correction is low frequency information and has no structure information. Isotropic diffusion can satisfy these two requirements but anisotropic smoothing may protect the structure. The weight λĜ balances these two opposing terms. In regions with high gradient value (potentially bright spots), the fidelity term is weighted more and hence protects the high value of S at those regions. This feature of S can help to get rid of bright spots. In regions with a low gradient value, the fidelity term is weighted less and hence S can be thoroughly smoothed. This feature of S can protect the original image contrast of I.

The Euler Lagrange equation for Equation 1 is
λĜ(S−Î)−ΔS=0 (2)
with boundary condition ∂S/∂\overline{n}=0, where n is the outward unit normal to the image boundary. ‘Δ’ is the Laplacian operator. By discretizing Equation 2, we derive the following evolution equations

$${S}^{n + 1} = \frac{[ \begin{matrix}{S}^{n} ( k + 1 , l ) + {S}^{n} ( k - 1 , l ) + \\ {S}^{n} ( k , l + 1 ) + {S}^{n} ( k , l - 1 )\end{matrix} ] + λ G \hat{I}}{λ \hat{G} + 4} \qquad ( 3 )$$

where k,l correspond to rows and columns of the image respectively, n is number of iterations. S⁰ is defined as Î. There are at least two approaches to terminate the iteration. One approach is to check the change in S after each iteration, and terminate the process when the change is less than a given threshold. Another simple approach to terminate the iteration is to fix the number of iterations. In a specific embodiment, the number of iterations is set.

Once the estimated sensitivity profile, S is generated, the corrected image Ĩ can be calculated by the following equation:

$$\tilde{I} = \frac{I}{S} {S}_{ave}$$

where Sₐᵥₑ is the average intensity of S over the image domain. Another way to write this equation is

$$\tilde{I} = \frac{1}{S} \times {‖ \frac{S}{I} ‖}_{2} \times {‖ I ‖}_{2} \qquad ( 4 )$$

∥•∥₂ is the operator for Frobenius-norm. The purpose of

$${‖ \frac{S}{I} ‖}_{2} \times {‖ I ‖}_{2}$$

The purpose of Sₐᵥₑ is to correct the intensity so that the average pixel intensity (in the image domain) is retained after correction. Because of the smoothness of S, no singularity problem exists.

### EXAMPLE 1

In this example, we evaluate an embodiment of the subject method by using both phantom and clinical data. For evaluation of accuracy, simulated phantom data was used. Histogram and correlation with true uniform image were used as criteria for accuracy. To test the stability, MRI images collected on different MRI systems (GE, SIEMENS, HITACHI) and for different organs (brain images, cardiac images, neurovascular images) were used. For comparison, the results using an embodiment of the subject method were compared with images corrected using Gaussian smoothing (M. S. Cohen, R. M. DuBois, and M. M. Zeineh, “Rapid and Effective Correction of RF Inhomogeneity for High Field Magnetic Resonance Imaging,” Human Brain Mapping, vol. 10, pp. 204-211, 2000), wavelet based method (F.-H. Lin, Y.-J. Chen, J. W. Belliveau, and L. L. Wald, “Removing Signal Intensity Inhomogeneity from Surface Coil MRI Using Discrete Wavelet Transform and Wavelet Packet,” presented at Engineering in Medicine and Biology Society, 2001, 23rd Annual International Conference of the IEEE, 2001) and homomorphic filtering method (J. W. Murakami, C. E. Hayes, and E. Weinberger, “Intensity Correction of Phased-Array Surface Coil Images,” Mag. Res. Med, vol. 35, pp. 585-590, 1996). The same extrapolated image was used in each method to solve the boundary enhancement of low intensity region problem.

Focusing on the evaluation of accuracy, histogram difference and correlation with true uniform image were used as criteria for accuracy. The histogram spectrum contained the intensity contrast information. The shape of the histogram spectrum of a well-corrected image should be similar to that of the true image. Hence it is reasonable to use the energy of the histogram spectrum difference (with true uniform image) as one criterion for uniformity evaluation. Suppose there are N bins in the normalized histogram h for image I, then the energy is defined as the Frobenius-norm of h_{C}−h_{T}, where h_{C} is the histogram of the corrected image, h_{T} is the histogram of the true uniform image. Less difference means better contrast protection. Another criterion for accuracy is the correlation with the true image. The correlation between two images describes the similarity of those two images. Hence a better intensity correction method generates a corrected image that has a high correlation with the true image.

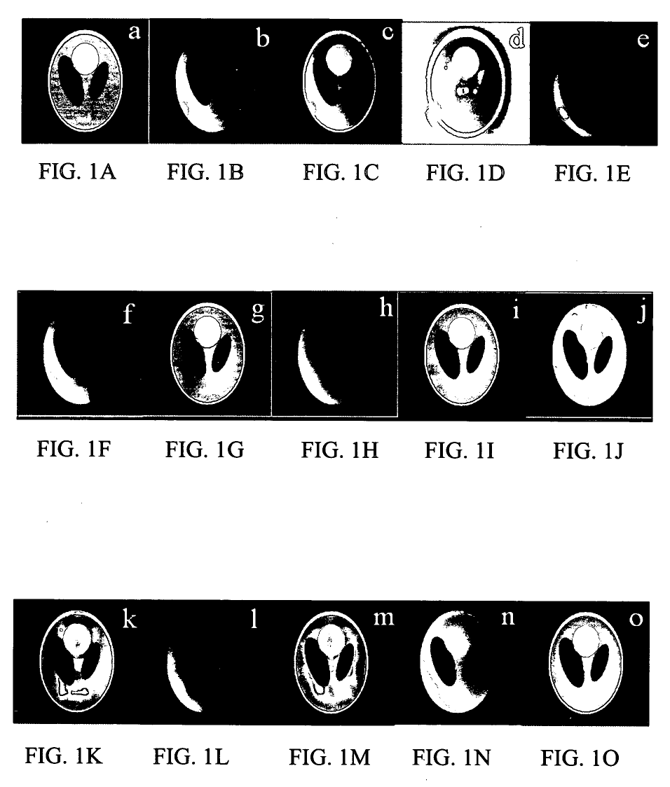

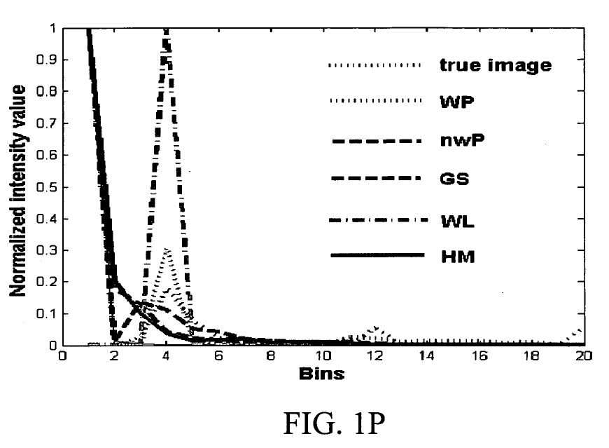

In this example, a modified Shepp-Logan phantom was used as the true image. The simulated B₁ field of a four-channel cardiac coil (Invivo Diagnostic Imaging, Gainesville, Fla.) was used as the sensitivity profile. To compare the results obtained using different methods, the parameters for each method were chosen to generate the best result for each method. For all the methods, threshold for the background was set to be 0.05×(maximum intensity); the same extrapolated image was used and the width of extrapolation was 20 pixels; the weight A for fidelity in the subject method was 0.1 and the iteration time was 1000; the distribution width for Gaussian smoothing was 60; the Daubeche bi-orthogonal wavelet was chosen for wavelet based method and the smoothing level was 3, i.e. an 8×8 matrix was retained from the wavelet transform; the width of the Hanning window for homomorphic filtering was 17. The gradient map (FIG. 1E) provides the weight for smoothing. Clearly, the gradient map has high value at the bright spots of the image. Visually, the sensitivity profile (FIG. 1F) estimated by the embodiment of the subject method is most similar to the true sensitivity profile (FIG. 1B); the corrected image (FIG. 1G) produced by the embodiment of the subject method has the best uniformity and image contrast. FIG. 1N shows that the histogram of the corrected image by the embodiment of the subject method (blue dots) is the most similar to the histogram of the true image (red dots). Table 1 shows the quantitative comparison. The first row is the energy of histogram difference. Smaller difference means more similarity of image contrast. The first row shows that all methods, except the embodiment of the subject method, damage the image contrast during intensity correction. However, the first row data shows the embodiment of the subject method enhances the image contrast. The second row is the relative correlation with the true image. The correlation between the corrupted image and the true image is set to be 1. The higher value of correlation means more similarity with true image. The correlations show again that the image corrected by the embodiment of the subject gradient weighted smoothing method is most similar to the true image.

TABLE 1
Qutative comparison of corrected images by different methods

| | Subject | | | | |
|---|---|---|---|---|---|
| | Method | Gaussian | Wavelet | Homomorphic | Corrupted |
| Histogram | 0.182 | 0.355 | 1.22 | 0.359 | 0.314 |
| Correlation | 2.29 | 2.15 | 0.142 | 1.807 | 1 |

Evaluation of Stability

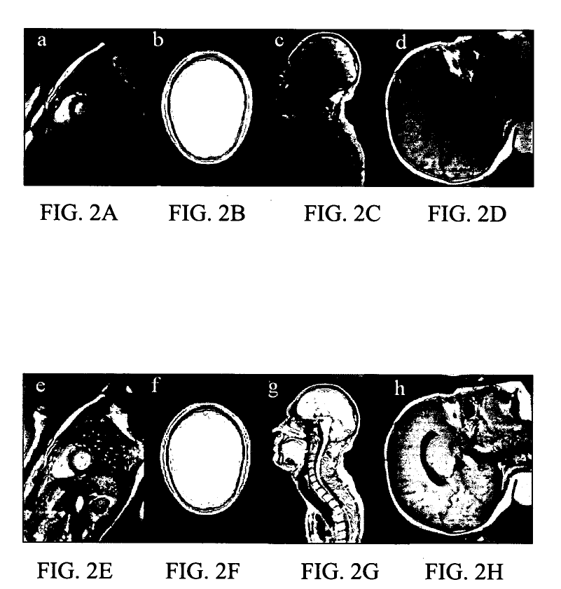

In order to evaluate stability, in the following experiments, the same default parameters were used. The results provided in Table 1 showed that the wavelet-based method is not accurate for removing bright spots. The wavelet based method was not used for the purpose of evaluating stability. For the embodiment of the subject method, default parameters were ε=0.05 (maximum intensity), ω=20, λ=0.01, and N=100; the default parameters in (M. S. Cohen, R. M. DuBois, and M. M. Zeineh, “Rapid and Effective Correction of RF Inhomogeneity for High Field Magnetic Resonance Imaging,” Human Brain Mapping, vol. 10, pp. 204-211, 2000) and (J. W. Murakami, C. E. Hayes, and E. Weinberger, “Intensity Correction of Phased-Array Surface Coil Images,” Mag. Res. Med, vol. 35, pp. 585-590, 1996) were used for Gaussian smoothing and homomorphic filtering, respectively. An 8-channel Neurovascular array (NVA, Invivo Diagnostic Imaging, Gainesville, Fla.) was used to collect sagittal and coronal phantom and clinical neurovascular data. Then a body coil was used to collect a low signal to noise ratio (SNR), but uniform, image of the same slice. The intensity corrected image should have high correlation with the body coil image. Different intensity correction methods were applied to the sum-of-squares image collected using the phased array coil. Table 2 shows relative correlation between corrected images and the body coil image. It shows that the embodiment of the subject gradient weighted smoothing method generates the best intensity correction in all cases by using the same set of parameters. FIGS. 2A-2H give more results by the embodiment of the subject method for different systems. Those images show again the stability of the embodiment of the subject method.

TABLE 2
Relative correlation between corrected images and body coil image

| | Phantom | | | Clinical | | |
|---|---|---|---|---|---|---|
| | Axial 3 | Sagittal | Coronal | Axial 3 | Sagittal | Coronal |
| Embodiment of | 1.4063 | 1.8395 | 1.1211 | 1.2753 | 1.2538 | 1.0903 |
| Subject Method | | | | | | |
| Gaussian | 1.2714 | 1.6753 | 0.9023 | 1.1876 | 1.1858 | 1.0244 |

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A method of image intensity correction, comprising:
a) receiving original image data for an original image, wherein the image data for the original image comprises a plurality of magnitude values corresponding to a plurality of pixels in the original image;
b) creating an intensity correction template, wherein the intensity correction template comprises a plurality of correction values corresponding to at least a portion of the plurality of pixels, wherein creating the intensity correction template comprises:
i) determining hole pixels and image support pixels based on the plurality of magnitude values corresponding to the plurality of pixels in the original image, wherein each of the pixels of the plurality of pixels is determined to be a hole pixel or an image support pixel,
ii) setting the correction values of the image support pixels in the intensity correction template to the magnitude values of the corresponding pixels of the original image; and
iii) setting the correction values for at least a portion of the hole pixels in the intensity correction template near the image support pixels, wherein each of the correction values for the hole pixels in the intensity correction template near the image support pixels are related to the correction values of the image support pixels with respect to which the hole pixel is near;
c) generating an intensity correction map, wherein generating an intensity correction map comprises altering the correction values of the image support pixels of the intensity correction template based on the values of the image support pixels of the intensity correction template and the values of the hole pixels of the intensity correction template near the image support pixel; and
d) producing corrected image data for a corrected image, wherein the corrected image data for the corrected image comprises a plurality of corrected magnitude values corresponding to the image support pixels, wherein the corrected magnitude value of each image support pixel is proportional to the magnitude value of the image support pixel in the original image divided by the correction value of the image support pixel in the intensity correction map.

2. The method according to claim 1,
wherein altering the correction values of the image support pixels of the intensity correction template is accomplished via Gaussian smoothing.

3. The method according to claim 1,
wherein altering the correction values of the image support pixels of the intensity correction template is accomplished via homomorphic filtering.

4. The method according to claim 1,
wherein altering the correction values of the image support pixels of the intensity correction template is accomplished via a wavelet based smoothing.

5. The method according to claim 1,
wherein altering the correction values of the image support pixels of the intensity correction template is accomplished via gradient weighted smoothing.

6. The method according to claim 1,
wherein altering the correction values of the image support pixels of the intensity correction template is accomplished via gradient weighted partial differential equation smoothing.

7. The method according to claim 1,
wherein altering the correction values of the image support pixels of the intensity correction template is accomplished via filtered gradient weighted smoothing method.

8. The method according to claim 1,
wherein determining hole pixels and image support pixels based on the plurality of magnitude values corresponding to the plurality of pixels in the original image comprises determining a pixel to be a hole pixel if the pixel's magnitude value is less than a threshold magnitude value.

9. The method according to claim 1,
wherein setting the correction values for at least a portion of the hole pixels in the intensity correction template near the image support pixels comprises setting the correction values for the hole pixels in the intensity correction template that are within a certain distance of an image support pixel in the intensity correction template.

10. The method according to claim 9,
wherein setting the correction values for at least a portion of the hole pixels in the intensity correction template that are within a certain distance of an image support pixel in the intensity correction template comprises:
determining boundary pixels, wherein a boundary pixel is an image support pixel that is adjacent to a hole pixel,
setting the correction values for the hole pixels that are within the certain distance of a boundary pixel to the correction value of a mirror-image pixel with respect to the boundary pixel, wherein the mirror-image pixel with respect to the boundary pixel is an image support pixel that is the certain distance from the boundary pixel as the hole pixel.

11. The method according to claim 1,
wherein altering the correction values of the image support pixels in the intensity correction template to produce an intensity correction map comprises:
determining a smoothing weight for each image support pixel and for each hole pixel near the image support pixel in the intensity correction template;
performing weighted smoothing, wherein weighted smoothing adjusts the correction value for each of the image support pixels based on the correction values and smoothing weights of the pixel's neighbors.

12. The method according to claim 10,
wherein the mirror-image pixel is determined via closest point method.

13. The method according to claim 11,
wherein determining a smoothing weight comprising calculating a gradient of the correction values in the intensity correction template so that each image support pixel and each hole pixel near an image support pixel has an associated gradient value; and
low pass filtering the gradient values in k-space.

14. A method of image intensity correction, comprising:
a) receiving original image data for an original image, wherein the image data for the original image comprises a plurality of magnitude values corresponding to a plurality of pixels in the original image;
b) generating an intensity correction map, wherein generating an intensity correction map comprises:
i) setting the correction values of the pixels intensity correction map to the magnitude values of the corresponding pixels of the original image; and
ii) altering the correction values of the pixels of the intensity correction map via gradient weighted smoothing, and
c) producing corrected image data for a corrected image, wherein the corrected magnitude value of each pixel of the corrected image is proportional to the magnitude value of the pixel in the original image divided by the correction value of the pixel in the intensity correction map.

15. The method according to claim 1,
wherein setting the correction values for at least a portion of the hole pixels in the intensity correction template near the image support pixels comprises setting the correction values for the hole pixels in the intensity correction template that are within 20 pixels of an image support pixel in the intensity correction template.

16. The method according to claim 1,
wherein setting the correction values for at least a portion of the hole pixels in the intensity correction template near the image support pixels comprises setting the correction values for the hole pixels in the intensity correction template that are within 50 pixels of an image support pixel in the intensity correction template.

17. The method according to claim 1,
wherein setting the correction values for at least a portion of the hole pixels in the intensity correction template near the image support pixels comprises setting the correction values for the hole pixels in the intensity correction template that are within 100 pixels of an image support pixel in the intensity correction template.
